(19) United States
(12) Patent Application Publication
(10) Pub. No.: US 2006/0088695 A1
(43) Pub. Date: Apr. 27, 2006

(54) Multilayer separable film or sheet

(76) Inventor: Theodore Coburn, Coventry, RI (US)

Correspondence Address: CHRIS A. CASEIRO, VERRILL DANA, LLP, ONE PORTLAND SQUARE, PORTLAND, ME, 04112-0586, US

(21) Appl. No.: 11/255,668

(22) Filed: Oct. 21, 2005

Related U.S. Application Data
(60) Provisional application No. 60/620,938, filed on Oct. 21, 2004.

(51) Int. Cl. B32B 3/00

(52) U.S. Cl. 428/172

(57) ABSTRACT

A multilayer film having two or more separable adjacent layers. The multilayer film includes adjacent layers formed of compositions of dissimilar primary materials. Optionally, at least one of the layers contains a slip additive to change the release tension between adjacent layers. The multilayer film may include an adhesive layer between layers, with the adhesive layer more adhesion compatible with one of the layers than the other. The multilayer film may be a relatively inexpensive means to produce labels, films, sheets, containers, etc., requiring protection or isolation of one surface without the additional processes of gluing together individual dissimilar layers. Applications include, but are not limited to, the multilayer film being used as a seal to secure containers, including envelopes, and being imprinted and used as a multilayer labeling system. In one preferred embodiment, at least one layer of the multilayer film undergoes a visibly observable change when the at least one layer is released from at least one other layer; the visibly observable change is useful for many purposes, including, but not limited to, serving as a security mechanism within a container seal which, when the seal is broken, provides evidence that the container was opened.

### CROSS REFERENCE TO RELATED APPLICATION

The present application claims the priority benefit of U.S. provisional patent application Ser. No. 60/620,938, filed Oct. 21, 2005, entitled “MULTILAYER SEPARABLE FILM OR SHEET” of the same named inventor. The entire contents of that prior application are incorporated herein by reference.

### BACKGROUND OF THE INVENTION

1. Field of the Invention

The present invention relates to seals, tapes, labels, and various coverings to be applied to substrates. More particularly, the present invention relates to such items that are intended to be removably applied to substrates, or to be themselves separable. Still more particularly, the present invention relates to security tapes and seals, such as for security envelopes, but is not limited thereto.

2. Description of the Prior Art

Presently, there are various methods employed to restrict unauthorized access to the contents of containers, including shipping containers, envelopes, and the like. There are also methods to detect whether such containers and envelopes have been tampered with, including unauthorized opening. These methods include, but may not be limited to, the application of a seal across the container opening, with the tearing or breaking of the seal signifying that the container may have been opened. Additionally, Tyvex® envelopes supplied by DuPont Corporation and others, includes adhesive-coated fibrous material, with the fibers or fibrils of the material visibly separated when the tape is pulled. While some of these security concerns were generated as a result for the need to protect information and materials from unauthorized visual observation, others were generated as a result of physical safety concerns. One famous example of that concern, the introduction of hazardous material to Tylenol® (products, spurred the generation of tamper-proof medicine containers. Unfortunately, sealing tape can be peeled and reapplied without apparent disruption. In addition, fibrous envelopes are relatively expensive to fabricate. Present means for securing medicine bottles vary widely and also add to the cost of the product.

More generally, there are a variety of applications for which it is desirable to be able to have a film or sheet material with characteristics that may otherwise be difficult to create in a single product. As one example, it would be desirable to minimize the potential contamination associated with plasticized materials, such as polyvinyl chloride (PVC), while retaining the advantageous characteristics thereof. Such may be the case with storage bags for fluids to be securely held and visible within the bags without contaminating the fluids within, such as blood bags. It may be necessary in that application to use the PVC for the purpose of welding the perimeter of the bag, but undesirable to have the fluid come in direct contact with the PVC. In that case, it would be desirable to have a relatively more inert material, such as polyethylene or polypropylene, in contact with the fluid.

In another example of an application in which it would be desirable to have a film or sheet, optionally transparent or opaque, having a surface to be protected until such time as that surface is to be exposed. For instance, it is common to have release paper or liners on a surface that may be tacky, have an adhesive surface, or otherwise that is not to be exposed to its environment until actually used for its intended purpose. The process of making the substrate with the desired protected characteristics, the release liner and an intervening material such as adhesive, is rather involved and therefore relatively expensive. It would be preferably to have such a film or sheet product have a protected layer and a protecting layer that may be fabricated in a single process.

Therefore, what is needed is a closing or sealing arrangement to secure containers, including envelopes. Further, what is needed is such alternative arrangement that is relatively inexpensive to produce without compromising the desired security. In addition, it is desirable to have a film or sheet that may be used as a label, such as a multilayer label, to provide information in a relatively small space, such as on a medicine bottle and be able to save the printed material such as for labeling pharmaceutical and prescription drug bottles. Still further, what is needed is a film or sheet system that may be fabricated in a process to form a multilayer arrangement in which at least one layer may be separated from the other without unduly compromising the functional characteristics of one or more of the layers.

### SUMMARY OF THE INVENTION

It is an object of the present invention to provide a closing or sealing arrangement to secure containers, including envelopes. It is also an object of the present invention to provide such a closing or sealing arrangement that is relatively inexpensive to produce without compromising the desired security. It is a further object of the present invention to provide a film or sheet that may be used as a label, such as a multilayer label, to provide information in a relatively small space, such as on a medicine bottle and be able to save the printed material such as for labeling pharmaceutical and prescription drug bottles. Moreover, it is an object of the present invention to provide a film or sheet system that may be fabricated in a process to form a multilayer arrangement in which at least one layer may be separated from the other without unduly compromising the functional characteristics of one or more of the layers.

These and other objectives are achieved in the present invention, which is a multilayer film or sheet including layers that are separable from one another. When the film or sheet is to be used as a way to show that a seal or closure has been opened, the layers are separable from one another in a manner that enables visual observation that such separation has occurred. When the film or sheet is to be used as a multilayer labeling system, such as to provide information of the contents of a relatively small container, such as a medicine bottle, the top layer of the film or sheet containing printed information may be removed, leaving the remaining layer(s) of the film or sheet on the container. When the film or sheet is to be used as a multilayer system to protect the surface of one of the layers with the structure of a layer adjacent thereto, at least one of the layers may be removed from one or more of the other layers without unduly compromising the structural and appearance characteristics of the remaining layer or layers, the removed layer or layers, or both. It is to be understood that the terms film and sheet may be used interchangeably herein.

The invention is a multilayer film or sheet that may be a label, a tape, or a seal, but that is not limited thereto. As a label, multiple layers may be applied to a container. Under controlled tensioning or pulling, individual layers may be separated, thereby enabling the user to remove the portion of the label containing printed information relatively easily, while leaving remaining layer(s) on the container. Such a multilayer label may be applied to medicine bottles, chemical containers, or any sort of container having a label that the user may wish to remove a portion thereof without distortion to the remainder of the label. The multilayer film or sheet of the present invention may be used as a tape, wherein two or more layers would be applied to the item to be covered. Pulling of the tape would separate the layers, thereby revealing the separated layers in a manner indicating that the tape had been compromised. The individual layers of the tape could be of distinct appearance, such as different coloring, making observation of the separation apparent. As a seal, such as for an envelope closure, the outer layers of the multilayer film would be affixed to the body and flap, respectively of the envelope, such as by an adhesive. Upon pulling of the flap from the envelope body, the layers of the film or sheet would separate, thereby providing clear visual information that the envelope had been compromised. As with the tape concept, the multilayer film or sheet as a seal may include individual layers of distinct appearance, readily showing the distinct appearances when separated. More generally, the present invention involves the fabrication of multilayer film in a way that ensures interlayer separation may occur when the layers are pulled apart.

The process for fabricating the separable film or sheet of the present invention differs from current processes for film and sheet fabrication generally in that it is the goal of the process to reduce the bond between layers of the multilayer structure rather than to enhance that bond. For example, the base structural component of each layer of a multilayer film tends to be the same for all layers. That is, if polyethylene is used as the base for one layer, it is generally used for all layers. The process of the present invention contemplates using differing base structures, such as polyethylene in one layer and polypropylene in the adjacent layer. The different base structure materials will not bond as well as like base structure materials. Additionally, additives, such as slip additives that reduce interlayer adhesion are included in the compositions of one or more layers of the film or sheet of the present invention. Further, the components of the individual layers of the multilayer film are preferably mixed and extruded separate from the mixing and extruding of the components of the other layers. Again, this method of processing reduces the likelihood of a strong interlayer bond. The extent to which differing materials, concentrations or slip additive, and separate extruding are employed determines the amount of force required to separate one layer from another.

The details of one or more examples related to the invention are set forth in the accompanying drawings and the description below. Other features, objects, and advantages of the invention will be apparent from the detailed description, accompanying drawings and appended claims.

### BRIEF DESCRIPTION OF THE DRAWINGS

FIG. 1 is a simplified diagrammatic view of a film or sheet processing system of the present invention to fabricate a separable film or sheet.

FIG. 2 is a simplified cross-sectional view of an example two-layer separable film of the present invention.

FIG. 3 is a simplified cross-sectional view of an example three-layer separable film of the present invention.

### DETAILED DESCRIPTION OF THE PREFERRED EMBODIMENT

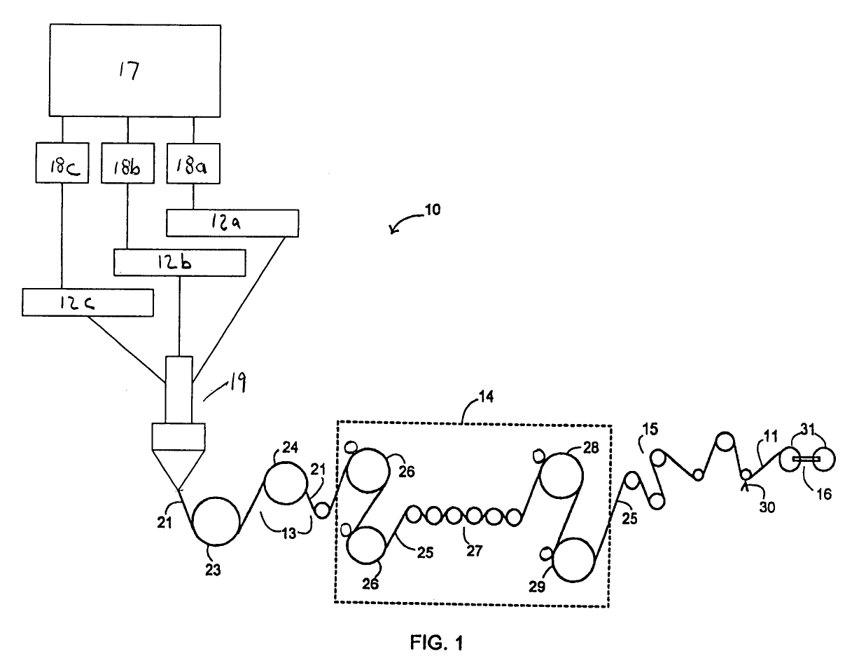

FIG. 1 shows a simplified diagrammatic view of a film fabrication system 10 used in the novel fabrication process of the present invention to create a novel multilayer film or sheet stock 11. Primary components of the system 10 include a plurality of extruders 12a-12c, a multilayer roll unit 13, a film-orientation unit 14, a corona treatment unit 15, and an end-product winder 16. The extruders 12 are used to extrude individual layers of materials including individual components selected to provide desired physical and visual characteristics of each layer. A primary component of any individual layer is a structural material selected from the group consisting of polyethylenes of various densities and/or molecular weights, polypropylenes, and copolymers of polyethylene and polypropylene. Other suitable materials as the primary component may include, but are not limited to, polyesters, polyvinyl chlorides, ethylene vinyl acetate, ethylene methacrylate, or other materials that may be of interest as a function of the particular application for the multilayer film/sheet. Additionally, for some applications, an intermediate layer may be primarily an adhesive material, which adhesive material may or may not require the same early stage mixing and processing required by individual layers having a polymeric material as the base material. In general, the components may be pelletized or in any form suitable for adequate mixing and extruding. It is noted that those skilled in the art will recognize that standard additives may be included in the mixtures of the layers of the multilayer film/sheet dependent upon the particular application. Such additives may be anti-blocks, anti-stats, and the like. It is of importance for the purpose of the present invention that adjacent materials are dissimilar, although if an adhesive is used as an intermediate layer material, it may be adhesive compatible with one adjacent layer but not the other.

Components may be delivered via tubes of a component material blender 17 into individual mixing hoppers 18a-18c, one set of feeder and hopper may be used for each of the extruders 12a-12c; however, in some cases, the same feeder may be used to supply more than one extruder, or multiple feeders may supply a lesser number of extruders. All of the selected components for a particular layer are then transferred from the hopper 18a-18c into the extruder 12a-12c for mixing at a selected temperature prior to transfer to a co-extrusion block and die 19. The extruders 12a-12c and the co-extrusion block and die 19 can be of any type known to those skilled in the art to be suitable for mixing and extruding components of the type described herein. The co-extrusion block and die 19 directs the respective separately mixed outputs from extruders 12a-12c into a single layer film or sheet that is multilayer extrusion 21. The separate mixing and extrusion of the individual layers via extruders 12a-12c aids in minimizing the interlayer bond between adjacent dissimilar materials.

The multilayer extrusion 21 is transferred from the co-extrusion block and die 19 to a first casting chiller roll 23 of the multilayer roll unit 13. The multilayer extrusion 21 may be in a range of thicknesses when first reaching the roll 23, dependent upon the ultimate function of the multilayer stock 11 to be produced. For example, the extrusion 21 may be approximately, but is not limited to, 5-40 mils thick as it moves to the first casting chiller roll 23. The extrusion 21 moves from the first chiller roll 23 to a second casting chiller roll 24. Rolls 23 and 24 may be of any suitable temperature, but preferably about 100° F. This chilling of the extrusion 21 acts to solidify it into a film-like material. From the second chiller roll 24, the extrusion 21 is delivered to the film-orientation unit 14.

In the orientation unit 14, the extrusion 21 is stretched and may be oriented into a film or sheet 25 that can range in thickness from about 1-40 mils, but can be thinner or thicker than that range, again, dependent upon the desired function of the stock 11. A pre-heater pair of rollers 26 at a temperature of about 200°-270° F. warms and softens the extrusion 21 after the chill casting stage of the process. A series of stretching rollers 27 at a temperature of about 240° F. act to considerably increase the length of the film/sheet 25. That step thins the film/sheet 25 and will also create a unidirectional molecular orientation that provides increased strength and stiffness in the film/sheet 25. It is possible to provide the stock 11 without this specific stretching step; however, the resultant film may have less strength, stiffness, and clarity than that developed during stretching.

In the next stage of the process, orientation process heat setting and then stress-relieving or relaxing of the film/sheet 25 occurs as the film/sheet 25 is transferred to a heat-stabilization roller 28, which may be one or more rollers, that is/are at a temperature in the range of about 270° F. to about 295° F. This imparts better stiffness and flatness in the end product in that the film/sheet 25 is unstressed as it moves across a cooling roller 29 that may be at ambient temperature. The heat-set rollers have individual drive controllers between two or more individual rollers so as to control the speed of the film passing therethrough. This is important to maintain the flow of the product through the continuous process.

From the orientation unit 14, the film/sheet 25 moves to the optional corona-treatment unit 15 where the film surface may be enhanced, such as for improved printability. Final processing of the film/sheet 25 may include cutting of rough film edges by a slitter 30. Scraps of the film/sheet 25 from the slitting process may be returned for re-introduction into the process and subsequent use. The final stock 11 is then wound onto transfer rolls 31 of the winder unit 16 for delivery to users. It is to be noted that the cross-wise (bi-directional) orientation of the film/sheet 25 and/or stock 11 may be further stretched and therefore increased by applying the film/sheet 25 or stock 11 to a tenter frame and heating in an oven (not shown). Additionally, it is optionally preferable to heat stabilize the finished film/sheet 25 product after biaxially stretching it. A blown film system known by those skilled in the art of the field of the present invention may be used to provide enhanced bi-directional strength of the stock 11 as an alternative to the extrusion system shown. Further, the extrusion 21 may not be oriented (stretched) finished products that do not require the characteristics associated with film orienting.

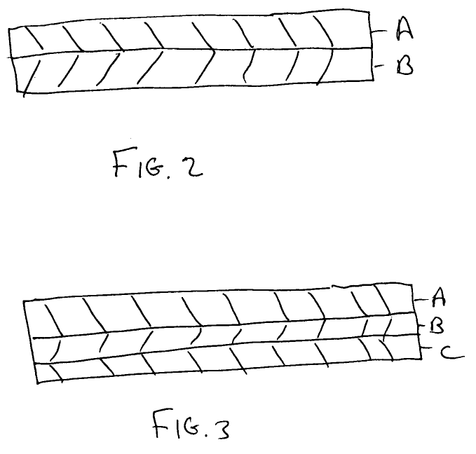

As illustrated in FIG. 2, an example of a stock 11 formed by the process of the present invention into a film, sheet, label, tape, or seal, includes two individual layers, identified as Layer A and Layer B. Layer A is formed of a mixture including a polyethylene base and a color concentrate, such as carbon black or other black component, either in a solid form or in a liquid carrier. The percentage of color concentrate selected determines the opacity and tint of Layer A; however, the majority percentage of the mixture is preferably the polyethylene base. In addition to the polyethylene and the color concentrate, the mixture for Layer A may also include a slip additive to enhance the likelihood that Layer A and Layer B of the stock 11 would separate under tensioning. A slip additive suitable for this purpose is the Ampacet™ low-density polyethylene base slip product #10061 available from the Ampacet Company located in Tarrytown, N.Y. Those skilled in the art will recognize that other slip additives may be suitable substitutes. The amount of slip additive to include in the mixture is dependent upon the desired required tension to cause Layer A and Layer B to separate from one another. It has been determined, however, that the individual layers may be separated (peeled apart) with an even-controlled tension without a slip additive being included in one or more of the layers, and that in doing so, they leave no fibrils, provided the adjacent layers are formed of dissimilar primary materials. Layer A may be formed by adding the three identified components to hopper 18a, for example, and extruding it through extruder 12a for example.

Layer B is formed of a mixture including a base of different composition than the base of Layer A; in this example, the base of Layer B is preferably polypropylene. In addition, the mixture for Layer B includes a color concentrate that is different from the color concentrate used in the mixture for Layer A. In this example, the color concentrate for Layer B is a white component, possibly in solid form or in a liquid carrier. The mixture for Layer B may include optional components including, for example, a printable additive such as the printable additive described in U.S. Pat. No. 6,136,439 entitled “Monolayer Polymeric Film And Method Of Fabrication” issued on Oct. 24, 2000, and U.S. Pat. No. 6,703,447 entitled “High Bi-directional Strength Monolayer Polymeric Film And Method Of Fabrication” issued Mar. 9, 2004. Both patents are in the name of the inventor of the present invention. The entire contents of both referenced patents are incorporated herein by reference. Layer B may be formed by adding the identified components to hopper 18b, for example, and extruding it through extruder 12b for example. Layer A and Layer B are separately mixed and extruded to maintain their independent characteristics. They are then layered one on top of the other and die cast through the co-extrusion block and die 19.

The combination of Layer A and Layer B through the stock formation process described with reference to FIG. 1, or other suitable film/sheet fabrication process, yields a separable film or sheet that includes a first layer of one color and a second layer of a different color. Because Layer A and Layer B are formed of different compositions and extruded separately, they do not adhere together as well as most multilayer extruded films and sheets. Instead, they are extruded separately and with components that make separation possible under tensioning. The amount of slip additive employed, as well as the base material selected, will determine the tension or force required to cause the separation of Layer A from Layer B.

Those skilled in the art will see that a variety of compositions may be employed to produce a variety of combinations of layers having varied separation limitations. As a label, for example, a plurality of layers may be mixed and extruded, each designed to be able to separate from the layers to which it is immediately adjacent. The part of the film positioned as the top layer may include a printing additive. That top layer may be separated from the underlying layer or layers after printing, optionally also after die cutting to form individual labels. The top layer may be a polypropylene and the underlying layer for separation may be polyethylene, with an optional adhesive layer adhering to the polypropylene therebetween. As a seal for an envelope, for example, a stock such as the one shown in FIG. 2 may be fabricated. The outer side of each layer may include an adhesive for attachment to the envelope body by one layer, and attachment to the closure flap for the other layer. The adhesive applied to the layers is preferably of greater adhering strength to the respective layers than is the interlayer bond. As a result, when the envelope flap is pulled from the envelope body, the respective layers remain where they are attached, but are separated from one another. The different coloring is thereby revealed, signifying that the envelope had been sealed and then opened. The color arrangement may also be selected such that a first color is observable when the two layers are joined, and when the layers of the film are separated; the individual layers are of a second and third color, respectively. For example, Layer A may be red, Layer B may be blue, and when combined together by sealing of the envelope, a single purple layer is seen. Upon opening the envelope, only the colors red and blue are observed.

A three-layer multilayer film version of the film/sheet stock 11 of the present invention is shown in FIG. 3. The three-layer film includes first layer, Layer A, second layer, Layer B, and third layer, Layer C. At least two adjacent layers are formed to minimize interlayer bonding such that they may be pulled apart under tension with minimal fibril production. The first and third layers Layer A and Layer C may be formed of the same primary material, such as polyethylene or polypropylene, and Layer B may be formed of the alternative of the two. That is, it may be polypropylene or polyethylene. Alternatively, Layer A may be a composition including first primary material, Layer C may be a composition including a second primary, and Layer B may be an adhesive having adhesion compatibility with one of Layer A and Layer C, but with minimal adhesion compatibility with the other. For example, Layer A may be polyethylene and Layer C may be polypropylene, with Layer B being an adhesive layer compatible with polypropylene. For fabrication purposes, Layer A may be associated with extruder 12a, Layer B with extruder 12b, and Layer C with extruder 12c of FIG. 1.

As an example of a three-layer film stock, the intermediate extruder 12b may be used to apply an adhesive as the center portion of the multilayer extrusion 21. The adhesive as the middle layer is preferably formed of a composition suitable for adhering to one of the other two layers, which one of the other two layers would be formed of a base polymeric material different from the base polymeric material of the other of the other two layers. For example, the layer from extruder 12a may be formed with polypropylene base and the layer from extruder 12c may be formed with a polyethylene base. Using as the intermediate layer an adhesive compatible for adhesion to polypropylene would ensure that under tension, the polyethylene-base layer would release form the adhesive/polypropylene combination. That is, the polyethylene layer would act as a release liner of the film/sheet 31. This arrangement would allow for the formation of labels, tapes, etc., to be supplied as a single construction without the requirement of combining adhesives and release liners in separate stages, as is the current process. A slip additive may be included in the composition of one or more of the layers of the three-layer or other multilayer films in order to change the release tension between adjacent layers.

Applications for the two-layer, three-layer and other multilayer films include: 1) bags configured for sanitary applications wherein it is desirable to have the layer with minimal contamination on the surface or leaching characteristics in direct contact with a material or fluid to be isolated, such as a blood bag; 2) note pads with light adhesion characteristics, removably affixable banners and posters; 3) liners, labels, and the like that have previously required release paper or liners; 4) embossed films and sheets; 5) hologram films and sheets; 6) labels for which no adhesive is desirable; 7) welded bags and containers; and 8) static cling films.

Optional embossing rollers (not shown) may be employed to produce an embossed, such as a pebbly surface on one of the external surfaces of the multilayer film, with the other layer acting as a release component. The optional embossing rollers may also be employed to produce a hologram on one of the external surfaces of the multilayer film, with the other layer acting as a release component. Embossing may be accomplished, for example, by embossing Layer A, making Layer B an adhesive layer with Layer A material compatibility, and Layer C dissimilar to Layer A and incompatible with Layer B such that it may be the release layer. For the film as a two-layer static cling film, Layer A may be formed with static characteristics and a base material that is different from the base material of Layer B. When ready for application, Layer B may be pulled from Layer A and applied to the surface to which it is to be removably joined, all without any adhesive. Layer A may also include printed material, such as advertisements, announcements, and the like as a window decal material.

While the example multilayer films shown in FIGS. 2 and 3 represent the individual layers as being of substantially equal thickness, the layers may not be of equal thickness. For example, Layer A of FIG. 2 may be formed much thinner than Layer B, such that Layer B may be used to carry Layer A through the process represented with regard to FIG. 1. In those applications for which a very thin layer of film, including films less than 1 mil thick, it is difficult to establish and maintain a uniform thickness. In some applications, films having a thickness of 0.6 mil or less are desirable including, for example, in the insulative films used in batteries. The process and film of the present invention may be used to make such a film, wherein Layer A fabricated of a composition including polypropylene, for example, may come out of extruder 12a much thinner than the layer coming out of extruder 12b, which may be a polyethylene of selectable density or molecular weight. The polyethylene layer, layer B, would carry the thinner layer, Layer A, through the stretching and heat setting steps. The resultant film stock 11, would then be separated, Layer A from Layer B, with Layer A, having a thickness of less than 1 mil, wound on winder 30 and Layer B returned to the process. Layers A and B for that purpose would have to be formed to reduce the release tension therebetween, such as by using the dissimilar materials indicated.

It is to be understood that the example multilayer combinations described herein are but representations of options for the arrangement of the separable film or sheet of the present invention. This description is not intended to limit the principle concept of the present invention. All equivalents are deemed to fall within the scope of this description of the invention as described by the following claims.

What is claimed is:

1. A multilayer film comprising:
a. a first layer of a composition including a first polymeric material; and
b. a second layer of a composition including a second polymeric material different from the first polymeric material and selected to reduce release tension between the first layer and the second layer.

2. The multilayer film of claim 1 wherein the first polymeric material is polyethylene and the second polymeric material is polypropylene.

3. The multilayer film of claim 1 further comprising within the composition of the first layer a slip additive for changing the release tension between the first layer and the second layer.

4. The multilayer film of claim 1 wherein the composition of at least one of the layers includes an additive to induce a visibly observable change in at least one layer when the two layers are physically separated from each other.

5. The multilayer film of claim 4 wherein both the first layer and the second layered are colored and the color of the first layer is not identical to the color of the second layer.

6. The multilayer film of claim 4 wherein one of the layers is clear and the other layer is colored.

7. The multilayer film of claim 1 wherein at least one of the first layer and the second layer is imprinted.

8. The multilayer film of claim 1 wherein the multilayer film is affixable to one or more substrates.

9. The multilayer film of claim 1 further comprising an adhesive layer between the first layer and the second layer, wherein the adhesive layer is selected to adhere more to one of the first layer and the second layer than to the other of the two layers.

10. A multilayer film comprising:
a. a first layer of a composition including a first material;
b. a second layer of a composition including a second material different from the first material; and
c. a third layer of a composition including a third material different from the second material,
wherein the three layers are configured to change a release tension between the first and second layers, the second and third layers, or the first and second layers and the second and third layers.

11. The multilayer film of claim 10 further comprising a slip additive included in the composition of at least one of the first layer, the second layer, and the third layer.

12. The multilayer film of claim 10 wherein the second layer is an adhesive material selected to adhere to the first layer rather than to the third layer.

13. The multilayer film of claim 10 wherein the first material and the third material are compositions having as a base material the same polymeric material.

14. The multilayer film of claim 10 wherein the polymeric material of the first material and the second material is polyethylene and the second material is a composition having a base material that is polypropylene.

15. The multilayer film of claim 10 wherein the polymeric material of the first material and the second material is polypropylene and the second material is a composition having a base material that is polyethylene.

16. The multilayer film of claim 10 wherein the composition of at least one of the three layers includes an additive to induce a visibly observable change to the at least one of the three layers or to the other layers when the at least one of the three layers is physically separated from the other layers.

17. The multilayer film of claim 16 wherein the material of the at least one of the three or more layers and the material of the other layers are colored, and the color of the material of the at least one of the three layers is not identical to the color of the material of the other layers.

18. The multilayer film of claim 16 wherein the material of the at least one of the three layers is clear and the material of the other layers is colored.

19. The multilayer film of claim 10 wherein the material of at least one of the first layer and the third layer is imprinted.

20. The multilayer film of claim 10 wherein at least one of the first layer and the third layer is embossed to produce a pattern on an external surface thereof.

21. The multilayer film of claim 10 wherein at least one of the first layer and the third layer is embossed to produce a hologram on an external surface thereof.
